(19) United States
(12) Patent Application Publication
(10) Pub. No.: US 2026/0180173 A1
(43) Pub. Date: Jun. 25, 2026

(54) Terminal equipment with a configurable antenna system

(71) Applicant: SAGEMCOM BROADBAND SAS, BOIS-COLOMBES (FR)

(72) Inventors: Jean-Philippe JAULIN, BOIS-COLOMBES (FR); Yves JEGONDAY, BOIS-COLOMBES (FR); Tatiana BEZZINA, BOIS-COLOMBES (FR)

(21) Appl. No.: 19/427,621

(22) Filed: Dec. 19, 2025

(30) Foreign Application Priority Data
Dec. 20, 2024 (FR) FR2414854

(51) Int. Cl. H01Q 3/24; H04B 17/373; H04W 72/54

(52) U.S. Cl. CPC H01Q 3/24; H04B 17/373; H04W 72/54

(57) ABSTRACT

A method of managing terminal equipment comprising an antenna system that may be configured according to at least one first configuration and one second configuration having degraded communication performance levels on at least one particular frequency band, the management method comprising the following steps: to detect at least one usable cell; to determine whether at least one particular usable cell, among the at least one usable cell, at least partially uses the particular frequency band; if this is the case, and if the antenna system is configured according to the second configuration, to perform an action aimed at moving the antenna system to the first configuration.

The invention relates to the field of cellular network terminal equipment, such as cellular gateways.

### BACKGROUND OF THE INVENTION

A Fixed Wireless Access Internet gateway (referred to, in this document, as a “cellular gateway”) is, conventionally, capable of communicating with an operator's cellular network by using different frequency bands.

However, the implementation of a frequency band in a wireless communication device involves the use of at least one antenna adapted to this frequency band. The geometric dimensions of an antenna are directly dependent on its working frequency band. These dimensions increase as the frequency decreases, such that, for example, an antenna suitable for implementing communications at 700 MHz will have larger dimensions than an antenna of the same type adapted for implementing communications at 2400 MHz.

As soon as a communication device imposes the implementation of a network of antennae, for example, a MIMO (Multiple Input Multiple Output) type communication, it is necessary to isolate each antenna from the other antennae of the same network to allow the signals operated by each antenna to be decorrelated. This isolation results in the use of multiple orientations, and polarisations, but above all, in the distance between the antennae of a network. As for the antenna itself, the distance between the antennae to ensure a minimum isolation value increases as the frequency decreases.

It is thus understood that, for any wireless communication device to function optimally, it is advantageous to be able to vary the configuration of the antenna system (for example, its geometric/dimensional configuration) to adapt it to the frequency band being used. The antenna system of the wireless communication device comprises, for example, a single antenna or an antenna network consisting of several antennae.

It is thus known to use antennae varying in size, such as those of historical radio receivers whose extendible and orientable strand allows manual adaptation as required. This type of antenna, equipped with two strands, is also used in some televisions.

It is also known to operate an antenna system whose number of antenna (e) is likely to vary as a function of the local operating conditions of radio frequency equipment. Thus, a cellular gateway is known, that integrates an internal antenna device (comprising one or more antennae), and may be connected to a removable external antenna device (comprising one or more antennae). The internal antenna device is sufficient in the majority of cases, however, the use of the external antenna device is very advantageous in difficult communication conditions. The antenna system used may thus be configured according to a first configuration wherein it comprises the internal antenna device and the external antenna device, and according to a second configuration wherein it comprises only the internal antenna device. The transition between one configuration and another is the responsibility of the user with regard to their own understanding of their environment.

Ideally, when the cellular gateway is equipped with a configurable antenna system, the user must configure the antenna system to optimise the performance levels of the cellular gateway and thus the communications in the cellular network. The configuration must also be made as a function of whether or not certain frequency bands are operated by the network of the operator in charge of communications. Indeed, there is no need to implement a more complex or cumbersome configuration of an antenna system when this is not necessary to obtain certain performance levels, or when the frequency band corresponding to this configuration is not operated by the operator in the user's area of use.

However, the user is not provided with any guidance to assist them in selecting the appropriate antenna system configuration.

As a result, any user who is not familiar with the technology is left to make largely subjective decisions about the best course of action to take so that the user may fully benefit from the cellular gateway under local conditions of use. This very frequently leads to the cellular gateway being used with degraded performance levels.

### AIM OF THE INVENTION

An aim of the invention is to improve the communication performance levels of a cellular gateway that uses a configurable antenna system.

### SUMMARY

In view of achieving this aim, proposed is a pre-defined cellular network, the terminal equipment comprising a processor module arranged to engage with an antenna system that may be configured according to at least one first configuration and one second configuration, the second configuration having degraded communication performance levels on at least one particular frequency band, the management method being implemented in the processor module and comprising the following configuration steps:
to detect at least one usable cell that may be used to connect the terminal equipment to the pre-defined cellular network;
to determine whether at least one particular usable cell, among the at least one usable cell, at least partially uses the particular frequency band;
if this is the case, and if the antenna system is configured according to the second configuration, to perform an action aimed at moving the antenna system to the first configuration;

Thus, as soon as the processor module of the terminal equipment detects at least one usable cell (suitable cell) that uses the particular frequency band, the processor module performs an action aimed at configuring the antenna system and/or having the antenna system configured, according to the first configuration (unless the antenna system is already in the first configuration). For example, this action may consist of notifying the user that it would be preferable to modify the configuration of the antenna system.

This ensures that, regardless of the cell with which the terminal equipment synchronises (at the present instant or in the future), the antenna system of the gateway is/will be configured so that the terminal equipment operates optimally—or, at the very least, that the user is aware of the relevance of this reconfiguration.

In one embodiment, the at least one first configuration and the at least one second configuration correspond to:
a folded or unfolded antenna system, or
different geometric or dimensional configurations, or
a connection or disconnection of one or more antennae, via one or more switches, without modifying the geometry or dimensions of the antenna system, or
a connection or disconnection of a removable external antenna device to the terminal equipment, or
different amplification regimes of amplifiers of a radio frequency chain of the antenna system.

In addition, proposed is a management method such as described previously, comprising a preliminary phase during which the configuration steps are implemented, the preliminary phase further comprising the step of synchronising the terminal equipment with the cellular network by using one of the usable cells.

In addition, proposed is a management method such as described previously, wherein, during the preliminary phase, the processor module performs a frequency sweep to detect the at least one usable cell.

In addition, proposed is a management method such as described previously, wherein the particular frequency band is a low frequency band, and wherein, during the preliminary phase, the processor module is arranged:
to determine whether the antenna system is configured according to the first configuration or the second configuration;
if the antenna system is configured according to the first configuration, to perform the frequency sweep according to increasing frequencies;
if the antenna system is configured according to the second configuration, to perform the frequency sweep according to decreasing frequencies;

In addition, proposed is a management method such as described previously, further comprising the steps of detecting that a user has voluntarily modified the configuration of the antenna system, and, if this is the case, of transmitting a notification to the user proposing that they repeat the preliminary phase.

In addition, proposed is a management method such as described previously, wherein the frequency sweep performed while repeating the preliminary phase uses a list of useful cells detected during a previous preliminary phase.

In addition, proposed is a management method such as described previously, comprising at least one current phase during which the configuration steps are implemented, the processor module detecting at least one usable cell by operating at least one item of information originating from the cellular network.

In addition, proposed is a management method such as described previously, wherein the at least one current phase comprising a first current phase during which the at least one item of information comprises an inter-cellular request for transfer to a target cell of the cellular network.

In addition, proposed is a management method such as described previously, wherein the at least one current phase comprising a second current phase during which the at least one item of information comprises information indicating the presence of at least one neighbouring cell of the cellular network located in the same geographical area as the terminal equipment.

In addition, proposed is a management method such as described previously, wherein the frequency sweep performed while repeating the preliminary phase uses information obtained during a second previous phase.

In addition, proposed is a management method such as described previously, wherein the action comprises transmitting a notification to a user of the terminal equipment to request that they configure the antenna system according to the first configuration.

In addition, proposed is terminal equipment comprising a processor module arranged to engage with an antenna system that may be configured according to at least one first configuration and one second configuration, the second configuration having degraded communication performance levels on at least one particular frequency band, the management method such as described previously being implemented in the processor module.

In addition, proposed is terminal equipment such as described previously, comprising a position sensor arranged to detect whether the antenna system is configured according to the first configuration or according to the second configuration.

In addition, proposed is terminal equipment such as described previously, the terminal equipment being a cellular gateway.

In addition, proposed is a system comprising the terminal equipment such as described previously, and the antenna system.

In addition, proposed is a system such as described previously, the antenna system being integrated into the terminal equipment.

In addition, proposed is a system such as described previously, the antenna system comprising at least one antenna not integrated into the terminal equipment and arranged to be connected to the terminal equipment.

In addition, proposed is a computer program comprising instructions which cause the processor unit of the terminal equipment such as described previously to execute the steps of the management method such as described previously.

In addition, proposed is a computer-readable storage medium on which the previously described computer program is stored.

The invention will be better understood in the light of the following description of a specific and non-limiting embodiment of the invention.

### BRIEF DESCRIPTION OF THE DRAWINGS

Reference will be made to the accompanying drawings, among which:

FIG. 1 shows a cellular gateway and the cellular network;

FIG. 2 shows the steps of a preliminary phase;

FIG. 3 shows the steps of a first current phase;

FIG. 4 shows the steps of a second current phase.

FIG. 5 shows the steps implemented when the “UNFOLD ANTENNA” indicator adopts the “TRUE” value;

FIG. 6 shows the steps implemented in the event of voluntary unfolding or folding of the antenna system by the user.

### DETAILED DESCRIPTION

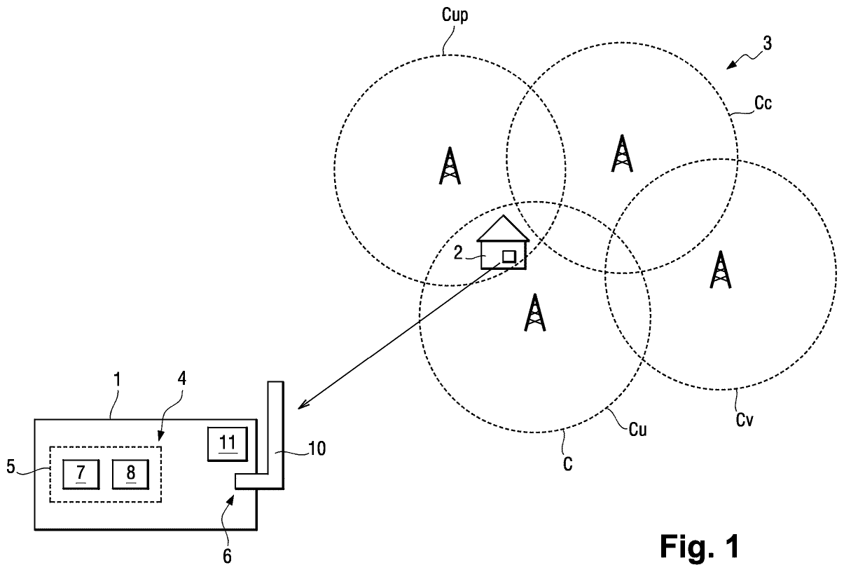

With reference to FIG. 1, terminal equipment 1, in this case, a cellular gateway 1, is installed in a user's home 2 and is intended to be connected to an operator's cellular network 3, to provide Internet access to the user's connected equipment. The cellular network 3, that comprises C cells, operates, for example, during the 4G/LTE standard.

The cellular gateway 1 comprises a communication module 4 comprising a processor module 5 and an antenna module 6.

The processor module 5 (electronic and software) comprises at least one processing component 7, that is, for example, a “general purpose” processor, a processor specialising in signal processing (or a DSP, i.e., a Digital Signal Processor), a processor specialising in artificial intelligence algorithms (a NPU-type, i.e., a Neural Processing Unit), a micro-controller, or a programmable logic circuit such as an FPGA (i.e., Field Programmable Gate Arrays) or an ASIC (i.e., Application Specific Integrated Circuit).

The processor module 5 also comprises one or more memories 8, connected to or integrated into the processing component 7. At least one of these memories 8 forms a computer-readable recording medium, on which is recorded at least one computer program (also known as application software) comprising instructions which cause the processor module 7 to execute at least some of the steps of the different phases of the management method that will be described.

The antenna system 6 is used by the cellular gateway 1 to communicate with the cellular network 3. In this case, the antenna system 6 is integrated with the cellular gateway 1.

The antenna system 6 may be configured according to at least one first configuration and one second configuration, the second configuration having degraded communication performance levels across at least one particular frequency band.

In one embodiment, the configuration change is a modification to the geometry or dimensions of the antenna system.

In this case, the particular frequency band comprises low frequencies, typically less than 1000 MHz, more particularly less than 900 MHz.

In other examples of implementation, it may be considered that the cellular network operates according to a standard of the 5G standard. In known manner per se, this standard provides several low frequency bands centred respectively around 700 MHz, 800 MHz, 900 MHz, 1.8 GHz, 2.1 GHz and 2.6 GHz, an intermediate frequency band between 3.4 GHz and 3.8 GHz and a high frequency band between 24.25 GHz and 27.5 GHz known as the Millimetre Band.

In other examples of implementation, the cellular network 3 operates according to several standards which coexist. For example, a sub-set of C cells of the cellular network 3 are operated according to a 4G standard, and another sub-set of C cells of the cellular network 3 are operated according to a 5G standard.

In this case, the antenna system 6 comprises an antenna 10 or a network of antennae 10 (subsequently referred to as the antenna 10) which may be unfolded or folded. The shape of the antenna 10 shown in FIG. 1 does not correspond to its actual shape. The antenna system 6 may further comprise one or more other antenna sub-systems, whose respective geometries are fixed in positions wherein they are able to transmit and receive on their operating frequency bands optimally.

In the first configuration, the antenna 10 is unfolded. When the antenna 10 is unfolded, all of the frequency bands which may be operated by the communication device 4 of the gateway 1 are available and the transmission/reception performance levels are optimal across the entire spectrum provided by the unfolded geometry of the antenna 10. In particular, the gain of the antenna system 6 covers all frequency bands optimally. In this position, all of the channels which may be used by the gateway 1 are used under optimal conditions. In the unfolded position, the antenna 10 is suitable for transmitting and receiving signals for all of the frequency bands implemented by the gateway 1.

In the second configuration, the antenna 10 is folded. In this case, the antenna system 6 makes it possible to cover only part of the spectrum optimally (in this case, the upper part of the spectrum), and because of the reduced dimensions, a lower part f the spectrum is only partially operable because the antenna system 6 is not able to provide sufficient gain (and/or sufficient isolation between the antennae, if the system 6 already comprises several antennae). In this folded position, it may be considered that the electrical signal, transmitted to a user's equipment via the gateway 1, may not be sufficient to allow the decoding of a signal that may be decoded while the antenna 10 of the antenna system 6 is unfolded. The misalignment of the 10 antenna with this frequency band causes a decrease in its gain and, in particular, reduces the level of the electrical signal received as well as the signal-to-noise ratio, thus affecting the decoding of a signal that may have been decoded if the antenna had been unfolded.

In this folded position, some of the frequency channels are covered in a degraded way due to the poor performance levels of the antenna system 6. In the folded position, the antenna 10 is adapted to transmit and receive signals for a first sub-set of the frequency bands implemented by the gateway 1, and has at least one limitation in its adaptability to transmit and receive signals for a second sub-set of the frequency bands implemented by the gateway 1.

The communication device 4 of the cellular gateway 1 also comprises detection means arranged to detect the configuration of the antenna system 6 (with the antenna 10 unfolded or folded).

In this case, the detection means comprise a position sensor 11 that is connected to the processor unit 5. The position sensor 11 produces an electrical signal that is representative of the configuration of the antenna system.

For example, the position sensor 11 may be an electrical micro-switch actuated by a movable portion of the antenna system 6 when the antenna 10 of the antenna system 6 is fully unfolded. The position sensor 11 may be any other position sensor that generates an electrical signal that may be operated by the processor unit 5.

The management method, that is implemented in the processor module 5, comprises the following configuration steps:
to detect at least one usable cell Cu that may be used to connect the cellular gateway 1 to a pre-defined cellular network, that, in this case, is the network 3 of the operator;
to determine whether at least one particular usable cell Cup, among the at least one usable cell Cu, at least partially uses the particular frequency band;
if this is the case, and if the antenna system 6 is configured according to the second configuration, to perform an action aimed at moving the antenna system 6 to the first configuration (unfolded antenna 10).

As will be seen, these configuration steps may be implemented during different operating phases of the cellular gateway 1.

The processor module 5 uses indicators to perform these different phases.

The “UNFOLD ANTENNA” indicator may adopt the “TRUE” or “FALSE” value. This indicator highlights the existence of a usable cell Cu (i.e., a “suitable cell”) of the cellular network 3 in the local horizon of the cellular gateway 1 that potentially requires the antenna 10 to be unfolded in order to be operated under the best conditions.

The term “usable cell Cu” is used to mean a cell C of the operator of the cellular network 3, on which the cellular gateway 1 is capable of synchronising so as to operate with nominal performance levels.

A “suitable cell” in the sense of 3GPP standardisation is a cell usable by the User Equipment (UE) with a complete service. It is thus a cell managed by the operator's network to which the user of the gateway 1 is subscribed. This implies that the gateway 1 detects a sufficient signal from this cell to be able to decode all of the information from the cell.

The “suitable cell” is different from an “acceptable cell” also defined by the standard, for which the gateway 1 is also able to decode all of the information, but may not access all of the functionalities. These may be, for example, cells managed by third-party operators, which may be deployed to a limited extent, for example, to make an emergency call.

The “USABLE CELLS” indicator may adopt the “IN PROGRESS” value or the “EMPTY” value or the “FULL” value. It highlights the presence of at least one usable Cu cell in the local horizon.

Attention is given initially to a preliminary phase P0, that is implemented at the start of the cellular gateway 1.

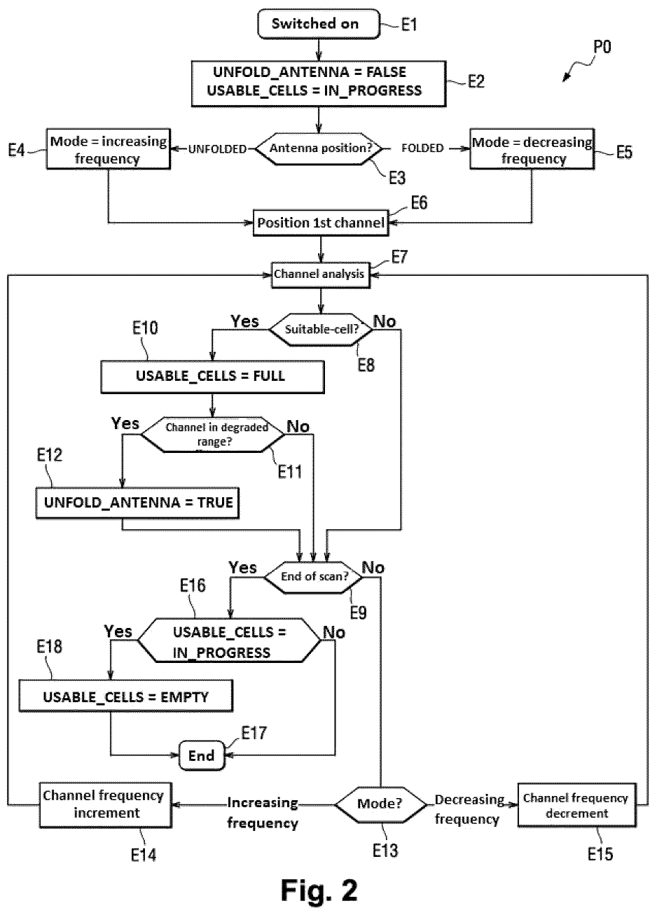

With reference to FIG. 2, this preliminary phase P0 begins with a step E1 during which the cellular gateway 1 is switched on. Alternatively, step E1 corresponds to a deliberate action aimed at configuring cellular gateway 1 such that it may be connected to the cellular network 3.

Then, the “UNFOLD ANTENNA” indicator is initialised to the “FALSE” value and the “USABLE CELLS” indicator is initialised to the “IN PROGRESS” value: step E2.

The processor module 5 then uses the sensor 11 to determine the configuration of the antenna system 6: first configuration (unfolded antenna 10) or second configuration (folded antenna 10): step E 3.

Advantageously, the list of frequencies and corresponding channels which may be used by the gateway 1 will be stored in a permanent memory (included in the memory or memories 8), in the form of a table, for example, to ensure that the application software constantly knows the predictable performance level of the antenna system 6 for a channel as a function of the configuration of the antenna system 6. This table will be compiled, for example, when the cellular gateway 1 is manufactured, and will contain, for each frequency channel that may be operated by the cellular gateway 1, at least one item of information relating to the performance level of the antenna system 6 in the folded position. This information may adopt the form of a binary value (NORMAL/DEGRADED) depending on whether the antenna system 6 in the folded position will have optimal or degraded performance levels at the frequency in question.

The processor module 5 will then attempt to detect at least one usable cell Cu that may be used to connect the cellular gateway 1 to the cellular network 3.

To this end, the processor module 5 performs a frequency sweep or frequency band sweep to detect the at least one usable cell Cu (this operation is also referred to as a cell scan or cell search).

As explained above, if the antenna system 6 is configured according to the first configuration, then the communication device 4 provides maximum performance levels across the entire frequency spectrum.

In this case, the frequency sweep is implemented at increasing frequencies (step E4). Thus, the sweep is performed by sweeping through operable frequencies starting from the lower part of the spectrum, thus prioritising the detection of cells which provide a large range.

For example, this frequency sweep will first be performed from the lowest frequency bands to the highest frequency bands as defined by the LTE standard in 3GPP TS 36.101 V 18.7.0 section 5.5, table 5.5-1 E-UTRA operating bands. For example, some of the bands 12, 17, 13, 14, 20, 26, 18, and 19 will be swept first, then the bands around 2100 MHz, then the bands around 2600 MHz, and then the bands around 3500 MHz. In one example, this frequency sweep is operated by the antenna system 6 with the antenna 10 and the other antenna sub-systems, and controlled by the processor module 5.

For a cellular 5G-type network, the sweep order, in this case, is chosen according to the low bands of the spectrum according to the document 3 38.101-1 V 18.7.0 section 5.

On the other hand, if the antenna system 6 is configured according to the second configuration, then the communication device 4 provides degraded performance levels in a part of its spectrum.

In this case, the frequency sweep is implemented at decreasing frequencies (step E5). The cell scan phase is performed by sweeping the frequencies least affected by the degraded performance levels of the antenna system 6 in the folded state, thus prioritising the detection of cells which may be operated by the antenna system 6.

The cellular gateway 1, that is capable of, for example, operating in the 3.5 GHz, 2.1 GHz and 700 MHz frequency bands, thus performs the analysis starting from the upper part of the spectrum whose performance levels are not impacted by folding the antenna system 6 and gradually decreasing the frequency of the channels until all of the frequency bands have been covered down to the lowest channel. The sweep order may be given according to the document 3GPP 36.101-1 V 18.7.0 for LTE or according to the document 3GPP 38.101 V 18.7.0 for 5G.

The processor module 5, following step E3, thus begins the frequency sweep by positioning itself on a first channel (step E6) and by starting with the analysis of the first channel (step E 7). The processor module 5 analyses this first channel and verifies whether there is a usable cell Cu on this channel (step E8). If this is not the case, the method moves on to step E9, that is described below.

If this is the case, the processor module 5 gives the “USABLE CELLS” indicator the “FULL” value (step E10).

Processing unit 5 informs the system of the existence of the usable cell Cu in the local horizon. Certain characteristics of this usable cell are stored in a list of usable cells. These characteristics may include: E-UTRA Absolute Radio Frequency Channel Number or EARFCN, the time alignment or timing downlink, the signal reception level of the common channels of this usable cell, certain information included in the Master Information Block (MIB) belonging to the System Information Block (SIB), etc.

The processor module 5 determines whether the usable cell is a particular usable cell Cup that at least partially uses the particular frequency band (in this case, the low frequencies): step E11.

If this not the case, the method moves on to step E9.

If this is the case, the processor module 5 gives the “UNFOLD ANTENNA” indicator the “TRUE” value (step E12).

Thus, if at some point during the analysis process by the processor module 5 of the information it receives, an analysed cell appears to be a usable cell and the frequency of its channel appears to belong to a frequency range with degraded performance levels due to folding the antenna 10 of the antenna system 6 (this is a “particular usable cell”), then an indicator is positioned to indicate to the system that at least one cell in the local horizon with theoretical radio range is implementing a frequency that, to be fully operated, requires the antenna system 6 to be unfolded.

The method moves on to step E9.

In step E9, the processor module 5 verifies whether the sweep is completed.

If this is not the case, the processor module 5 verifies whether the antenna system 6 is in the first configuration or the second configuration (step E13). If the antenna system is in the first configuration, the processor module 5 increments the channel frequency, or selects a frequency band whose frequencies are greater than those which have already been swept, to be analysed (step E14), and the method moves on to step E7. If the antenna system 6 is in the second configuration, the processor module 5 decrements the channel frequency, or selects a frequency band whose frequencies are lower than those which have already been swept, to be analysed (step E15), and the method moves on to step E7.

In step E9, if the sweep is completed, the processor module 5 verifies whether the “USABLE CELLS” indicator has the “IN PROGRESS” value (step E16).

If not, the method moves on to step E17, and ends.

If this is the case, the processor module 5 gives the “USABLE CELLS” indicator the “EMPTY” value (step E18). The method moves to step E17, and ends. Thus, if the analysis process implemented by the processor module 5 has reached the frequency of the last operable channel without having detected a usable cell, the processor module 5 uses this value of the “USABLE CELLS” indicator to inform the system of the absence of a usable cell in the local horizon.

At the end of the analysis by the processor module 5 of the entire radio environment that is accessible to the cellular gateway 1, the following information is known:
a “USABLE CELLS” indicator that may adopt the values “FULL” or “EMPTY” according to whether at least one or no cell usable by the processor module 5 has not been detected;
optionally, the exhaustive list of usable cells detected and their characteristics;
an “UNFOLD ANTENNA” indicator that may adopt the values:
   “TRUE” if at least one usable cell has been detected in a band fully operated by the unfolded antenna 10 but that may have been detected accidentally while the antenna 10 was folded;
   “FALSE” if no usable cells have been detected in such a band.

It must be noted that, once at least one usable cell has been detected (step E10) and its eligibility for step E12 has been determined, the process may be directly diverted to the final step E17.

The implementation of the rest of the method, and in particular, the continuation of the frequency sweep, is optional and non-essential from the moment a usable cell is detected.

Indeed, depending on the implementations, the gateway 1 may trigger a synchronisation with the network as soon as it has detected its first usable Cu cell, or it may wait to constitute a list to classify it, and thus select the one that will have the best conditions to establish communications.

The continuation of the sweep makes it possible, in particular, to detect the “UNFOLD ANTENNA” indicator at this stage, after having swept the entire spectrum down to the low frequencies, even though a usable Cu cell would have been detected in the high frequencies at the start of the sweep.

As explained above, the configuration steps also comprise the step, if necessary, to perform an action aimed at moving the antenna system 6 to the first configuration. This step may be performed as soon as the “UNFOLD ANTENNA” indicator adopts the “TRUE” value, and will be described below.

The preliminary phase P0 further comprises the step of synchronising the cellular gateway 1 with the cellular network 3 by using one of the usable cells Cu. After step E17, the gateway 1 implements the synchronisation on the cellular network 3 of the operator by using one of the usable cells Cu that it has detected. Gateway 1 thus reaches a camped normally state according to the modalities provided for by the standard (reference standardisation available on the website www.3gpp.org) thanks to the cell selection mechanism.

The gateway 1 is now synchronised on the network 3. As soon as this activation has succeeded, the network core of the operator, via the eNodeB network for an LTE type network or the gNB network for a 5G type network (radio base stations) will be responsible for controlling gateway 1 to give it instructions to improve communication in near real-time.

The management method further comprises at least one current phase during which the configuration steps are performed. The current phases may be repeated when the gateway 1 is in operation (as is the preliminary phase P0 in fact, as will be seen below).

The detection step, during these current phases, does not implement a frequency sweep as is the case for the preliminary phase P0. The processor module 5 detects at least one usable cell Cu by operating at least one item of information originating from the cellular network 3.

Indeed, as soon as the cellular gateway 1 is synchronised with the cellular network 3 (in the camped normally state within the meaning of the standard), the latter will control the cellular gateway 1 to make it execute a certain number of operations necessary for maintaining the communication link in the conditions most adapted to the environmental conditions (choice of the base station, choice of the cell, physical parameters of the transmitter of the cellular gateway, etc.). To this end, the network 3 operates a certain number of protocol messages.

In an optional first current phase P1, the at least one item of information may thus comprise a request for an inter-cellular transfer to a target cell Cc of the cellular network 3.

One category of protocol message thus relates to an explicit request coming from the network core that forces the cellular gateway 1 to attempt to connect to another cell in its immediate environment. This procedure is described in the above-mentioned standard as a transfer procedure. It is engaged by the network 3 as soon as the latter experiences an overload, or when the propagation conditions with the cell are no longer satisfactory.

The manager of the network core owns and operates the geographical location information of the base stations of their own network and the characteristics of each of them. The manager is thus able to predict the presence of the cells which they operate in an area potentially located in the local horizon comprising all of the base stations within radio range of the cellular gateway 1.

The inter-cellular transfer request may be an indirect request. This may be a measurement request to receive measurement information. The command issued by the network core is, for example, the RRC connection reconfiguration command, that comprises the RRC measurement field. Operating this request, together with the measurement information requested by the network core, makes it possible to determine the frequency channel of the target cell Cc.

Since the network manager knows the position of the cells C of the network 3, receiving an inter-cellular transfer request to a target cell Cc indirectly makes it possible for the gateway 1 to detect this target cell as being a usable cell Cu.

Operating this cell measurement request is thus a reliable indicator of the presence of said cell in a geographical area surrounding the cellular gateway 1 at a distance potentially compatible with setting up communications.

Advantageously, this inter-cellular transfer request is also an indicator of a communication condition that may be improved.

As soon as the cellular gateway 1 receives such a handover command to a cell C whose channel corresponds to an operation degraded by the system 10 with the antenna 6 in the folded position, then the general “UNFOLD ANTENNA” indicator will be positioned at the “TRUE” value.

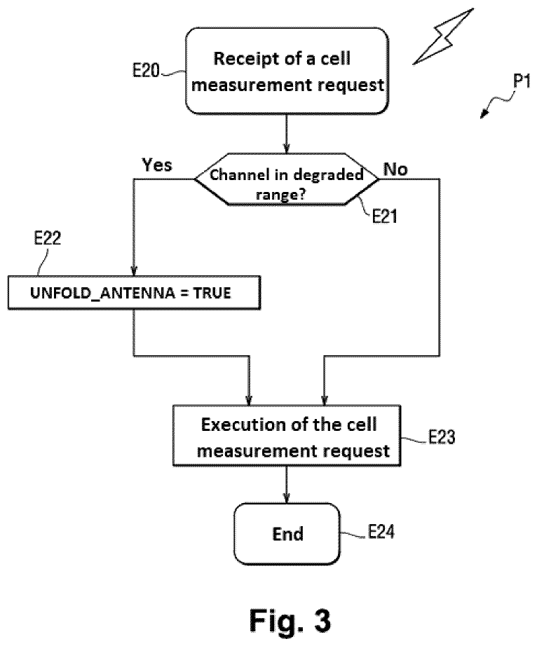

With reference to FIG. 3, the first current phase P1 begins with step E20.

The gateway 1 receives a measurement request on a target cell Cc. The processor module 5 thus detects that this target cell Cc is a usable cell Cu.

The processor module 5 determines whether this cell at least partially uses the particular frequency band: step E21 (thus if it is a particular usable cell).

If this is the case, the processor module 5 gives the “UNFOLD ANTENNA” indicator the “TRUE” value: step E22. The method moves on to step E23. In step E21, if the cell does not use the particular frequency band, the method moves directly on to step E23.

Gateway 1 executes the network request (e. g., measurements on the cell). The first current phase Pl ends:
step E24.

In an optional second current phase P2, the at least one item of information, originating from the network 3 and making it possible for the gateway 1 to detect at least one usable cell Cu, may also comprise one item of information indicating the presence of at least one neighbouring cell Cv of the cellular network 3 located in the same geographical area as the cellular gateway 1.

As soon as it is synchronised with the cellular network 3 of the operator, the cellular gateway 1 is able to receive, and thus to operate, the system information blocks (SIB) contained in the Broadcast Control Channel (BCCH) received permanently from the cell in question.

The manager of the network core owns and operates the geographical location information of the base stations of their own network and the characteristics of each of them. The manager is thus familiar with the cells which they operate in an area potentially located in the local horizon comprising all of the base stations within radio range of the cellular gateway 1.

The gateway 1, by operating, in particular, the fields SIB3 (Intra Frequency Cell Reselection) , and/or SIB4 (Intra Frequency Neighbour Cell) SIB5 (Inter Frequency Neighbour Cell), is thus able to detect the presence in its vicinity of a neighbouring cell Cv belonging to the network 3 of the operator and using at least one frequency belonging to a range or band of frequencies with degraded performance levels by folding the antenna 10 of the antenna system 6.

As soon as such a neighbouring cell Cv is detected, then the general “UNFOLD ANTENNA” indicator will be positioned at the TRUE value.

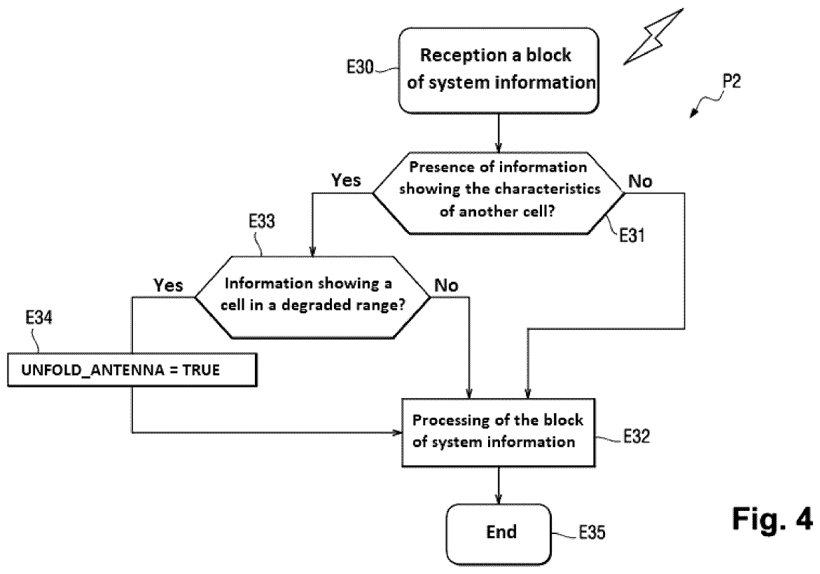

With reference to FIG. 4, the second current phase P2 begins with step E30. The gateway 1 receives a block of system information from the core of the network.

The processor module 5 determines whether this block of system information comprises one item of information relating to the presence of at least one neighbouring cell Cv of the cellular network 3 located in the same geographical area as the cellular gateway 1: step E31

If this not the case, the method moves directly on to step E32.

If this is the case, the processor module 5 determines whether this neighbouring cell Cv at least partially uses the particular frequency band (by using the information transmitted by the network 3): step E33.

If this is not the case, the method moves on to step E32.

If this is the case, the processor module 5 gives the “UNFOLD ANTENNA” indicator the “TRUE” value: step E34.

The method moves on to step E32.

The cellular gateway 1 performs the processing of the system information block.

The method moves on to step E35, and ends.

As explained above, the configuration steps, which may be implemented during the preliminary phase P0 or during a current phase P1 or P2, comprise the step, if necessary, to perform an action aimed at moving the antenna system 6 to the first configuration.

The previously described methods have highlighted various methods for positioning the “UNFOLD ANTENNA” indicator from different situations encountered by the cellular gateway 1 during its operation.

As soon as this indicator moves from the “FALSE” default value to the “TRUE” value, then the processor module 5 will highlight that the antenna 10 of the antenna system 6 that is in its folded position, must advantageously be unfolded to optimally operate the entire frequency band.

In particular, the folding out (or unfolding) of the antenna 10 of the antenna system 6 would make it possible to significantly improve the communication performance levels for frequencies which are actively operated by the network 3 in an environment close to the user.

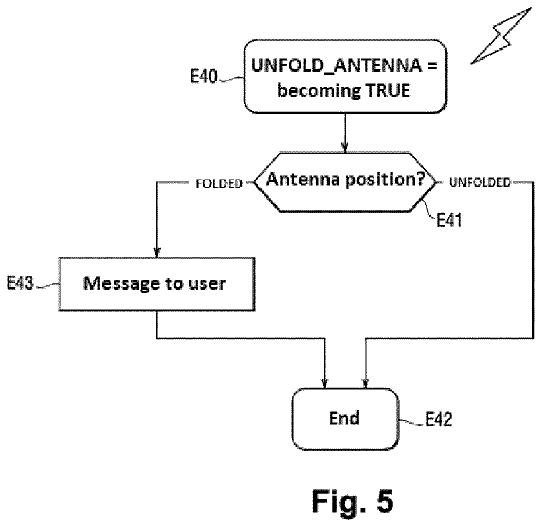

FIG. 5 shows an example of implementing a process intended to prompt the user to the unfold antenna 10 of the antenna system 6.

The method begins with step E40. The processor module 5 moves the “UNFOLD ANTENNA” indicator from the “FALSE” value to the “TRUE” value (transition).

The processor module 5 uses the sensor 11 to determine the actual configuration of the antenna system 6: step E41.

If the latter is located in the first configuration (unfolded antenna 10), the method moves on to step E42, and ends.

If the latter is in the second configuration (folded antenna 10), the processor module 5 performs the action aimed at moving the antenna system 6 to the first configuration: step E43. Then, the method moves on to step E42, and ends.

This action consists, for example, in issuing a notification intended for the user to notify them of the situation and to request that they configure the antenna system 6 according to the first configuration, i.e., to unfold the antenna 10 of the antenna system 6.

This notification may adopt different forms, such as a message on display of the cellular gateway 1, an illuminated indication on the cellular gateway 1, an audible notification, an indication on a configuration page of the gateway, an SMS, an email, etc.

For example, a message such as “The performance levels of the cellular gateway may be improved”. To this end, it may be preferable to unfold the antenna system.

Normal operation of the gateway 1 then resumes immediately without waiting for immediate action from the user. A reconfiguration is thus not obligatory, it is entirely possible for the user not to reconfigure the antenna system 6, for example, because they have not seen the message, or because they are satisfied with the “degraded” operating performance levels of the gateway 1 and do not intend to unfold the antenna 10.

Advantageously, to prevent a repetition of the notifications, the processor module 5 waits a relatively long period of time before issuing a second notification. This period of time lasts typically between 1 minute and 24 hours.

On the contrary, to help take notifications into account, the processor module 5 waits a relatively short period of time before issuing a second notification. This period of time lasts typically between 1 minute and 60 minutes.

A step may also be set up to confirm the user's acceptance of the situation by means of an explicit action (tick box, validation, etc.) aimed at accepting the fact that the user does not want to unfold the antenna 10 of the antenna system 6 and that they thereby accept the degraded operating conditions.

It must be noted that there are specific cases which highlight difficult conditions which may be significantly improved by unfolding the antenna 10 of the antenna system 6.

For example, as soon as the “USABLE-CELLS” indicator displays the value “EMPTY” (step E18, FIG. 2) and the antenna 10 of the antenna system 6 is in the folded position, then the sufficient conditions for communications with the antenna system 6 in its second configuration are not satisfied.

In this case, the cellular gateway 1 is unusable with the antenna 10 in the folded position.

Another critical case relates to the situation highlighted in step E22 in FIG. 3, while the cell measurement request relates to a channel whose frequency belongs to a frequency range with degraded performance levels due to folding the antenna system 6.

In this case, the cellular gateway 1 does not make it possible to respond correctly to the commands of the network core (handover) with the antenna 10 in the folded position.

Advantageously, both of these cases may be the subject of a particular notification to the user, different from that described above. This different notification makes it possible to significantly improve the availability of the cellular gateway 1 because there is a greater probability that the reconfiguration is actually performed.

The notification may be similar to the previous notification, but adding more definitive features such as a colour, an audible signal, or vocabulary more adapted to the alert level(s).

For example, a message such as “The performance levels of the equipment is insufficient”. It may be envisaged that the antenna system may have to be unfolded to allow a “communication”.

Advantageously, to prevent a repetition of the notifications, the processor module 5 waits a relatively long period of time before issuing a second notification. This period of time lasts typically between 1 hour and 24hours.

On the contrary, to assist in taking notifications into account, the processor module 5 waits a relatively short period of time before issuing a second notification. This period of time lasts typically between 1 minute and 60minutes.

Again, a step may also be set up to confirm the user's acceptance of the situation by means of an explicit action (tick box, validation, etc.) aimed at accepting the fact that the user does not want to unfold the antenna system 6 and that they thereby accept the degraded operating conditions.

It must also be noted that the user may, at any time, decide to modify the configuration of the antenna system 6. This action may be the consequence of a notification or alert presented by operating gateway 1 as previously described, but still, it may also be the result of an arbitrary decision.

As described in step E3 in FIG. 2, the processor module 5 may evaluate the position of the antenna 10 of the antenna system 6 and is thus able to detect a modification to the configuration of the antenna system 6.

When the configuration of the antenna system 6 is modified by the user, the operation of the gateway 1 as described in this case may continue, and the communication system as a whole will converge towards the best communication conditions.

However, advantageously, a complete resynchronisation with the 3 network would make it possible for convergence to occur more rapidly by prioritising the detection of cells C whose frequencies are best adapted to the performance levels of the antenna system 6 in its current position.

Thus, it may be envisaged, that when this switching has been detected, for the user to be notified as described in the preceding paragraphs, and also for the user to be proposed the option of a resynchronisation.

Thus, when the processor module 5 detects that the user has actually modified the configuration of the antenna system 6, the processor module 5 issues a notification to the user to propose that they repeat the preliminary phase P0 (in FIG. 2).

For example, a message such as “The geometry of the antenna system has just been modified. Would you like to restart a synchronisation with the network to benefit from rapid support of the communication conditions?” may be envisaged.

As soon as the user accepts the resynchronisation, then the preliminary phase P0 is restarted.

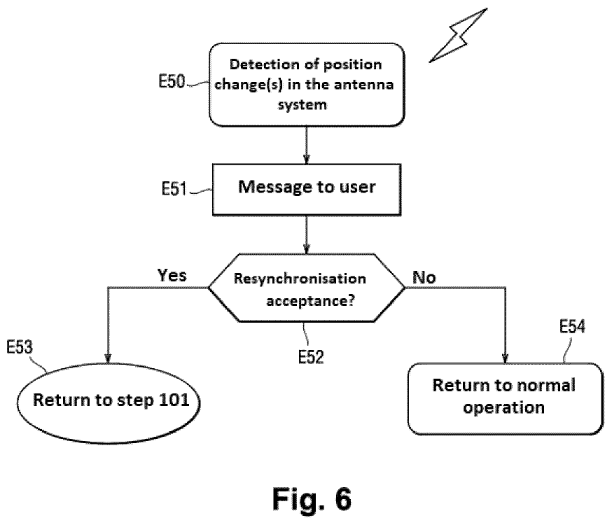

With reference to FIG. 6, the following method is implemented.

The processor module 5 detects the modification to the configuration of the antenna system 6: step E50.

The processor module 5 transmits a notification to the user, proposing that they repeat the preliminary phase P0 (and thus to perform a resynchronisation): step E51.

The processing unit 5 determines if the resynchronisation is accepted: step E52. If this is the case, the method moves on to step E2 of the method shown in: step E53. Otherwise, the method ends, and gateway 1 returns to normal operation: step E54.

When a resynchronisation is accepted, after returning to step E2, the preliminary phase P0 may be optimised by operating the exhaustive list of usable cells Cu that was established during the previous preliminary phase P0. In fact, a sweep performed with the antenna 10 of the antenna system 6 in the folded position, analysing a channel in a degraded range, i.e., for example, a sweep performed in frequency bands close to 700 MHz whereas the antenna is a 700 MHz antenna and is folded, may have identified one or more usable cells Cu. This indicates that the usable cell(s) Cu identified are geographically very close, because, despite the folded state of the antenna 10, the latter is able to find usable cells Cu. An optimisation of the preliminary phase P0, in this case, would involve performing a sweep as a function of the previously identified usable cells.

The frequency sweep performed while repeating the preliminary phase P0 thus uses a list of useful cells Cu detected during a previous preliminary phase P0.

Another possible optimisation of the preliminary phase when a resynchronisation is accepted, is to operate the information transmitted by the active cell in the SIB3 SIB4 SIB5 during the second current phase P2 (FIG. 4). This information has been previously stored. For example, the neighbouring cells indicated in the SIB5 information are stored, in particular, the cells whose frequency bands are affected by the functioning of the folded antenna. An optimisation of the preliminary phase P0, in this case, would be to perform a sweep as a function of the previously recorded information from neighbouring cells.

The frequency sweep performed while repeating the preliminary phase P0 thus uses information obtained during a previous second phase P2.

Of course, the invention is not limited to the embodiment described, but covers any variant coming within the scope of the invention as defined by the claims.

The terminal equipment, wherein the management method is implemented, is not necessarily a cellular gateway. The management method may be implemented in any equipment integrating the cellular network access technology. For example, it may be a laptop computer, a tablet, a smartphone, etc.

As described above, the antenna system comprises an antenna. The antenna system may comprise several of these.

The antenna system may comprise a network of antennae, e.g., at 700 MHz, to perform a MIMO.

The antenna system may consist of several antennae each covering part of the spectrum, whose signals are combined by means of a diplexer. In this case, the “fold” function may relate to only large antennae intended to operate in low frequencies. Again, the antenna system in its unfolded position has maximum efficiency across the entire expected spectrum, whereas in its folded position, its efficiency is reduced in a part of the spectrum.

As explained above, the antenna system may be configured according to at least two configurations: a first configuration having first communication performance levels in at least one particular frequency band, and one second configuration having second communication performance levels lower than the first performance levels in the at least one particular frequency band.

The specific frequency band is not necessarily a low-frequency band.

The different configurations do not necessarily correspond to a folded or unfolded antenna system. In one example, it may also involve connecting or disconnecting one or more antennae, via one or more switches, without modifying the geometry or dimensions of the antenna system.

The antenna system may comprise at least one antenna not integrated into the cellular gateway and arranged to be connected to the cellular gateway. For example, the cellular gateway may integrate an internal antenna device (comprising one or more antennae), and may optionally be connected to a removable external antenna device (comprising one or more antennae). The antenna system may thus be configured according to a first configuration wherein it comprises the internal antenna device and the external antenna device (and thus wherein the external antenna device is connected to the gateway), and according to a second configuration wherein it comprises only the internal antenna device (and thus wherein the external antenna device is not connected to the gateway).

The action performed by the processor module aimed at moving the antenna system into the first configuration, may be different from that described in this case.

In the example described above wherein the antenna system implements switches for activating and deactivating of one or more antennae, without modifying the geometry or dimensions of the antenna system 6, the processor module 5 is configured to, as a function of the decision taken, control the switch(es) so as to connect the antenna whose performance levels are degraded (e. g., at 700 MHz).

According to another example, the processor module is configured to adjust the amplification regime of the amplifiers (e.g., Power Amplifier (also referred to as “PA”), or Low Noise Amplifier (also referred to as “INA”), of the radio frequency chain of the antenna 10 of the antenna system 6. The second configuration corresponds to an “under-supply” of the PAs degrading the performance levels of the antenna 10 wherein its reception performance is degraded, making it less likely to detect its operational frequency band nominally. The first configuration corresponds to a nominal power supply for the PAS, making the antenna 10 nominally operational for reception in its frequency band. As a function of the decision made, the processor module 5 is configured to move the antenna 10 from its second configuration to its first configuration by adjusting the amplification regime. Thus, in “folded” mode, the antennae are less effective because the amplifiers operate in degraded mode. If the decision “unfold antenna” is made, the amplifiers are automatically configured in nominal mode.

The means for detecting the configuration of the antenna system does not necessarily comprise a position sensor. It may, for example, be a sensor measuring an electrical magnitude (current, voltage) depending on the configuration of the antenna system.

1. A method of managing terminal equipment of a pre-defined cellular network, the terminal equipment comprising a processor module arranged to engage with an antenna system that may be configured according to at least one first configuration and one second configuration, the second configuration having degraded communication performance levels on at least one particular frequency band, the management method being implemented in the processor module and comprising the following configuration steps:
to detect at least one usable cell that may be used to connect the terminal equipment to the pre-defined cellular network;
to determine whether at least one particular usable cell, among the at least one usable cell, at least partially uses the particular frequency band;
if this is the case, and if the antenna system is configured according to the second configuration, to perform an action aimed at moving the antenna system to the first configuration.
the at least one first configuration and the at least one second configuration corresponding to:
a folded or unfolded antenna system, or
different geometric or dimensional configurations, or
a connection or disconnection of one or more antennae, via one or more switches, without modifying the geometry or dimensions of the antenna system, or
a connection or disconnection of a removable external antenna device to the terminal equipment, or
different amplification regimes of amplifiers of a radio frequency chain of the antenna system.

2. The management method according to claim 1, comprising a preliminary phase during which the configuration steps are implemented, the preliminary phase further comprising the step of synchronising the terminal equipment with the cellular network by using one of the usable cells.

3. The management method according to claim 2, wherein, during the preliminary phase, the processor module performs a frequency sweep to detect the at least one usable cell.

4. The management method according to claim 3, wherein the particular frequency band is a low frequency band, and wherein, during the preliminary phase, the processor module is arranged:
to determine whether the antenna system is configured according to the first configuration or the second configuration;
if the antenna system is configured according to the first configuration, to perform the frequency sweep according to increasing frequencies;
if the antenna system is configured according to the second configuration, to perform the frequency sweep according to decreasing frequencies;

5. The management method according to any claim 2, further comprising the steps of detecting that a user has voluntarily modified the configuration of the antenna system, and, if this is the case, of transmitting a notification to them proposing that they repeat the preliminary phase.

6. The management method according to claim 3, wherein the frequency sweep performed while repeating the preliminary phase uses a list of useful cells detected during a previous preliminary phase.

7. The management method according to claim 1, comprising at least one current phase during which the configuration steps are implemented, the processor module detecting at least one usable cell by operating at least one item of information originating from the cellular network.

8. The management method according to claim 6, wherein the at least one current phase comprises a first current phase during which the at least one item of information comprises an inter-cellular request for transfer to a target cell of the cellular network.

9. The management method according to claim 7, wherein the at least one current phase comprises a second current phase during which the at least one item of information comprises information indicating the presence of at least one neighbouring cell of the cellular network located in the same geographical area as the terminal equipment.

10. The management method according to claim 9, wherein the frequency sweep performed while repeating the preliminary phase uses information obtained during a previous second phase.

11. The management method according to claim 1, wherein the action comprises transmitting a notification to a user of the terminal equipment to request that they configure the antenna system according to the first configuration.

12. A terminal equipment comprising a processor module arranged to engage with an antenna system that may be configured according to at least one first configuration and one second configuration, the second configuration having degraded communication performance levels on at least one particular frequency band, the management method according to any one of the preceding claims being implemented in the processor module.

13. The terminal equipment according to claim 12, comprising a position sensor arranged to detect whether the antenna system is configured according to the first configuration or according to the second configuration.

14. The electrical equipment according to claim 12, the

15. A system comprising the terminal equipment according to claim 12, and the antenna system.

16. The system according to claim 15, the antenna system being integrated into the terminal equipment.

17. The system according to claim 15, the antenna system comprising at least one antenna not integrated into the terminal equipment and arranged to be connected to the terminal equipment.

18. The computer program comprising program code instructions for executing the steps of the management method according claim 1 when said program is executed by a computer.

19. The computer-readable storage medium on which the computer program is stored, according to claim 18.

20. The management method according to claim 8, wherein the at least one current phase comprises a second current phase during which the at least one item of information comprises information indicating the presence of at least one neighbouring cell of the cellular network located in the same geographical area as the terminal equipment.
